(19) United States
(12) Patent Application Publication
(10) Pub. No.: US 2024/0375291 A1
(43) Pub. Date: Nov. 14, 2024

(54) APPARATUS, SYSTEMS, AND METHODS FOR OPERATING ROBOTS IN AN ASSISTED DRIVE MODE

(71) Applicant: 6 River Systems, LLC, Waltham, MA (US)

(72) Inventors: Christopher Cacioppo, Somerville, MA (US); Hector Padilla, Chelsea, MA (US); Taliza Sanchez, Brooklyn, NY (US); Maxwell Brandon Hurd, Calgary (CA)

(21) Appl. No.: 18/315,246

(22) Filed: May 10, 2023

(51) Int. Cl. B25J 13/08; B25J 5/00; B25J 9/16

(52) U.S. Cl. CPC B25J 13/085; B25J 5/007; B25J 9/1664

(57) ABSTRACT

Apparatus, systems, and methods for operating robots in an assisted drive mode are disclosed. An example robot includes a body; at least one motor carried by the body; a handle; at least one strain sensor coupled to the handle; and circuitry to determine a measure of force applied to the handle based on one or more outputs of the at least one strain sensor; and cause the at least one motor to generate an output during the application of force to the handle to cause the robot to move responsive to the force applied to the handle based on the measure.

### FIELD OF THE DISCLOSURE

This disclosure relates generally to robots and, more particularly, to apparatus, systems, and methods for operating robots in an assisted drive mode.

### BACKGROUND

During operation, a robot may move autonomously in an environment in response to, for instance, instructions generated based on user inputs. In some instances, such as for maintenance purposes, a user may manually move the robot by exerting force on the robot.

### BRIEF DESCRIPTION OF THE DRAWINGS

FIG. 1 illustrates an example system including a robot and assisted drive mode control circuitry for controlling movement of the robot in accordance with teachings of this disclosure.

FIG. 2 is a block diagram of an example implementation of the assisted drive mode control circuitry of FIG. 1.

FIGS. 3 and 4 illustrate an example robot including a handle in accordance with teachings of this disclosure.

FIGS. 5 and 6 illustrate another example robot including a handle in accordance with teachings of this disclosure.

FIG. 7 is a flowchart representative of example machine readable instructions and/or example operations that may be executed, instantiated, and/or performed by example programmable circuitry to implement the assisted drive mode control circuitry of FIG. 2.

FIG. 8 is a block diagram of an example processing platform including programmable circuitry structured to execute, instantiate, and/or perform the example machine readable instructions and/or perform the example operations of FIG. 7 to implement the assisted drive mode control circuitry 138 of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIG. 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

As mentioned above, during operation, a robot may move autonomously in an environment in response to, for instance, instructions generated based on user inputs. In some instances, the robot may be moved manually by a user for reasons such as maintenance purposes, to direct the robot to a fiducial to enable the robot to update position data relative to the environment, etc. Manual movement of the robot involves the user exerting force on (e.g., pushing) the robot to cause the robot to move. However, some robots are not ergonomically designed for manual movement based on their size, shape, and/or weight. Also, some robots may be carrying a heavy load. As a result, the user may have difficulty moving the robot manually, may risk injury when moving the robot manually, etc.

Disclosed herein are example robots (e.g., autonomous robots) including a handle control system to enable a user to maneuver the robot by applying force to a handle of the robot. In some examples disclosed herein, the robot switches from an autonomous drive mode to an assisted drive mode in response to force applied at the handle. In the assisted drive mode, motor(s) of the robot facilitate movement of the robot while the user exerts force on the handle. In some examples, the handle can be moved between a stowed position and a deployed position relative to a body of the robot. In some examples, the robot switches to the assisted drive mode when the handle is in the deployed position.

Example handle control systems disclosed herein include sensors to generate outputs indicative of force applied on the handle by the user. Examples disclosed herein include circuitry to cause the robot to move in response to the force applied at the handle. For example, the circuitry can determine acceleration of the robot based on outputs of the sensors indicating force applied at the handle. The circuitry communicates with motor(s) of the robot to facilitate movement of the robot while the user is exerting force on the handle. Thus, examples disclosed herein provide for assisted manual movement of the robot. In some examples, the circuitry adjusts acceleration of the robot based on the force applied at the handle and the weight of the robot (e.g., where mass can be derived from outputs of weight sensors at the robot).

Example handle control systems disclosed herein determine (e.g., predict) an intent of the user with respect to movement of the robot. For example, the circuitry can analyze measurements output by sensors located at, for instance, opposing ends of the handle to determine a direction in which the robot should turn. Based on analysis of the differential sensor measurements, examples disclosed herein can infer a user intent to turn the robot to the right or left (e.g., where greater force may be applied by the hand associated with the direction in which the user wishes to turn the robot and reflected in the output(s) of the sensor(s) proximate to the relevant hand). In some examples, a drive profile for a user can be generated and saved. The user drive profile can define characteristics for the assisted drive mode for a particular user, such as preferred acceleration, minimum force thresholds for causing the robot to move, etc.

Some examples of robots disclosed herein have a form factor designed for facilitating carrying of inventory. For instance, the robot may have a form factor that substantially resembles a shopping cart or a push cart in which a handle extends along a portion of a body of the robot to enable a user to push or pull the robot. The body defines a storage area to receive and support goods placed therein during transport of the robot. Some example robots disclosed herein include forks defining a platform to support a load (e.g., a form factor resembling a pallet jack truck). Examples disclosed herein enable acceleration and direction of the robot to be controlled via the same input mechanism (i.e., force applied on the handle of the robot). Thus, examples disclosed herein can be distinguished from vehicles in which direction and acceleration inputs are decoupled and require two separate inputs (e.g., a steering wheel and accelerator pedal, or joysticks). Separate direction and acceleration inputs may involve specialized training and inputs that are not intuitive to an operator. Thus, examples disclosed here are advantageous with respect to robots having, for instance, a shopping cart form factor.

In examples disclosed herein, the sensor(s) of the handle can include strain sensors (e.g., strain gauges). Strain sensors such as strain gauges can be used instead of, for instance, capacitive touch sensors, because strain gauges can detect small changes in force, which can be used to recognize variations (e.g., slight variations) in force applied by the user's hands. Further, strain gauges can measure both tension and compression, while capacitive touch sensors measure changes in capacitance, which is an indirect measure of force. Also, as compared to capacitive touch sensors, strain gauges can detect force applied when the user is wearing gloves (e.g., safety gloves) and are more durable when exposed to impact or vibration, thereby providing for robust measurements of amplitude of force on the handle in an environment such as a warehouse.

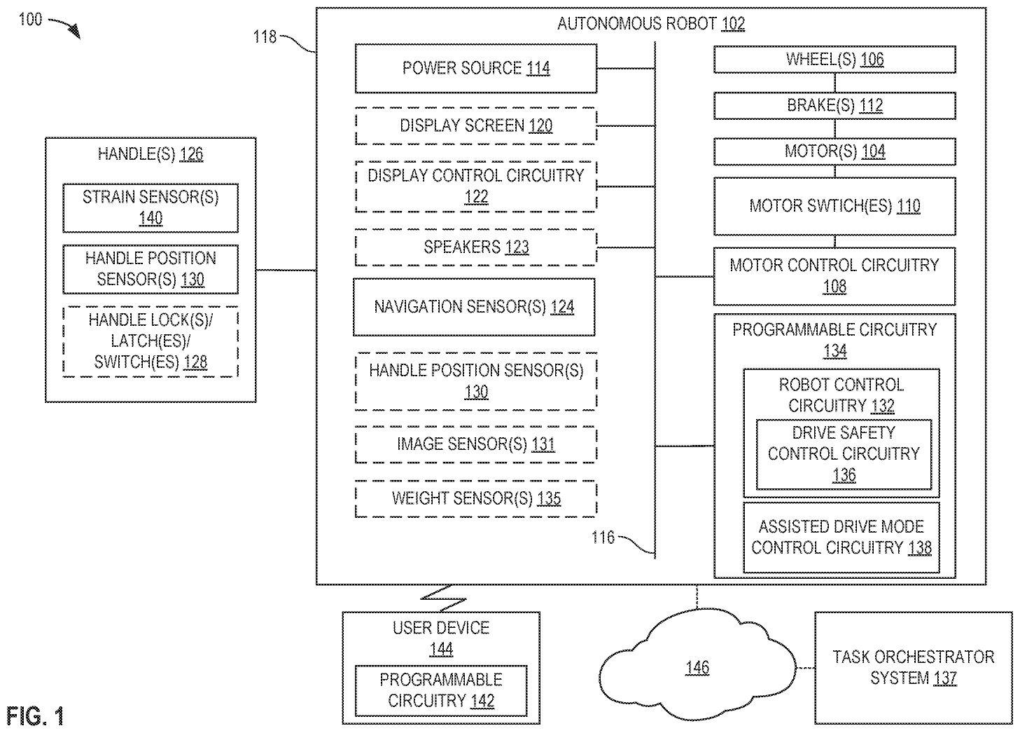

FIG. 1 illustrates an example system 100 for controlling movement of an autonomous robot 102 in an assisted drive mode in accordance with teachings of this disclosure. The autonomous robot 102 of FIG. 1 can include, for example, a cart including a storage area (e.g., bin(s), shelve(s), fork(s)) for carrying inventory (e.g., one or more objects) retrieved from a storage location in a warehouse or other environment. Although examples disclosed herein discussed in connection with autonomous robots, examples disclosed herein could be used with other types of robots.

The example autonomous robot 102 of FIG. 1 includes one or more motors 104 (e.g., electric motor(s) and/or other means for driving movement of the robot 102 via wheel(s) 106 of the robot 102). The example robot 102 includes motor control circuitry 108 and one or more motor switches 110 to control operation of the motor(s) 104. The motor control circuitry 108 includes electronics (e.g., hardware and software component(s)) to control, for example, a speed of the robot 102. The motor switches 110 can control a flow of current to the motor(s) 104 based on, for example, instructions generated by the motor control circuitry 108. The example robot 102 includes brake(s) 112, or more generally, braking mechanism(s) that serve as means for slowing or stopping movement of the robot 102.

In some examples, the robot 102 of FIG. 1 includes a display screen 120 to present content to a user of the robot 102. In some examples, the display screen 120 is a touch screen to enable the user to interact with data presented on the display screen 120 by touching the screen 120. A display control circuitry 122 (e.g., a graphics processing unit (GPU)) of the example robot 102 of FIG. 1 controls operation of the display screen 120 and facilitates rending of content (e.g., display frame(s) associated with graphical user interface(s)) via the display screen 120. In some examples, the robot 102 includes speaker(s) 123 to provide audio outputs. The robot 102 of FIG. 1 includes a power source 114 such as a battery to provide power to the motor(s) 104 and other components of the robot 102 communicatively coupled via a bus 116. A body, housing, or frame 118 of the robot 102 carries, contains, encloses, and/or otherwise supports electrical component(s) of the robot 102 that enable operation of the robot 102.

The example robot 102 of FIG. 1 includes one or more handle(s) 126, or means for guiding the robot 102. As disclosed herein, in some examples, the handle(s) 126 are separately coupled to the body 118 of the robot 102 and/or separately movable relative to the body 118. For instance, the handle(s) 126 can move between a stowed (e.g., folded, retracted) state and a deployed (e.g., unfolded, extended) state relative to the robot body 118. In some examples, the handle(s) 126 include lock(s), latch(es), and/or switch(es) 128 to secure or otherwise maintain the handle(s) 126 in the stowed position. In some examples, the handle(s) 126 include handle position sensor(s) 130 to output signal(s) indicative of movement of portion(s) of the handle(s) 126 (e.g., to indicate a change in position of the handle(s) from the stowed position to the deployed position). In some examples, the handle position sensor(s) 130 output signal(s) indicating a change of state of the lock(s), latch(es), or switch(es) 128 (e.g., to indicate that handle(s) 126 have been released from the lock(s) 128, a state of the switch 128 has been changed to release the handle 126, etc.). Additionally or alternatively, a user can press a button or an input at the display screen 120 to release the handle(s) 126. In some examples, the handle position sensor(s) 130 are additionally or alternatively carried by (e.g., coupled to) the body 118 of the robot 102. For instance, the handle position sensor(s) 130 carried by the robot body 118 can include proximity sensor(s) to output signal(s) indicative of a proximity of one or more portions of the handle(s) 126 to the body of the robot 102, thereby indicating that the handle(s) 126 are in the stowed position.

The example robot 102 includes a robot control circuitry 132 to control movement of the autonomous robot 102. In the example of FIG. 1, the robot control circuitry 132 is implemented by programmable circuitry 134 of the robot 102. The example robot control circuitry 132 of FIG. 1 controls autonomous movement or locomotion of the robot 102 in a first drive mode, or an autonomous drive mode. In the autonomous drive mode, the robot 102 moves to a location in an environment without or with limited user input control at the robot 102 during movement of the robot 102.

When the robot 102 is in the autonomous drive mode, the robot control circuitry 132 generates instructions to, for example, control travel of the robot 102 along a travel path to a location in an environment including the robot 102. For example, the robot control circuitry 132 generates instructions to cause the robot 102 to turn, travel forward, adjust speed, etc. The robot control circuitry 132 defines a travel trajectory for the robot 102 when the robot 102 is operating in the autonomous drive mode. The instructions generated by the robot control circuitry 132 can be transmitted to, for instance, the motor control circuitry 108. The robot control circuitry 132 includes drive safety control circuitry 136 that performs obstacle detection during travel of the robot 102, causes the robot 102 to perform maneuvers for collision avoidance, etc. The robot control circuitry 132 transmits the instructions with respect to autonomous movement (e.g., locomotion) of the robot 102 to the motor control circuitry 108 to cause the motor(s) 104 to move the robot 102.

The example autonomous robot 102 of FIG. 1 includes sensor(s) to provide information to the robot control circuitry 132 with respect to, for example, a location of the robot 102 in the environment (e.g., the warehouse), an orientation of the robot 102 in the environment, a proximity of the robot 102 (e.g., the body 118 of the robot 102) relative to external object(s) in the environment (e.g., to detect a potential collision), and/or other properties of the robot 102 (e.g., whether the robot 102 is carrying a load). For example, the robot 102 can include navigation sensor(s) 124 such as a satellite-based geographical positioning system (e.g., a global position system (GPS)), optical sensor(s), and/or other types of sensors. The robot control circuitry 132 analyzes data from the navigation sensor(s) 124 to, for example, adjust a trajectory of the robot 102 and generate corresponding instructions based on the outputs of the sensor(s) 124. In some examples, the robot 102 includes image sensor(s) 131 to generate image(s) of the surrounding environment during operation of the robot 102. The robot control circuitry 132 can analyze image data (e.g., using computer vision) output by the image sensor(s) 131 to, for instance, recognize object(s) in the environment, determine a location of the robot 102, etc. In some examples, the robot 102 includes weight sensor(s) 135 to measure, for example, a weight of a load carried by the robot 102 at a given time. In some examples, the robot control circuitry 132 determines a speed of the robot 102 based on the weight of the load carried by the robot 102.

The robot control circuitry 132 can generate the instructions to cause the robot 102 to move based on, for example, instructions received from a task orchestrator system 137 in communication with the robot control circuitry 132. The task orchestrator system 137 can manage workflows for the robot 102 and/or other robots in the environment, can assign user(s) (e.g., operator(s)) to perform task(s) in connection with the robot(s) 102, etc. As illustrated in FIG. 1, the robot control circuitry 132 can wirelessly communicate with the task orchestrator system 137 (e.g., via cloud-based device(s) 146). In some examples, the robot control circuitry 132 additionally or alternatively generates the instructions to cause the robot 102 to move based on inputs received at the robot 102 (e.g., via the display screen 120). For example, an instruction from the task orchestrator system 137 and/or a user input at the robot 102 can indicate an object to be retrieved from a warehouse in which the robot 102 disposed. The example robot control circuitry 132 of FIG. 1 can determine a trajectory of the robot 102 to the location of the object in the warehouse based on, for instance, previously defined rule(s) indicating a location of the object in the warehouse.

The autonomous robot 102 can also operate in a second drive mode, or a manual drive mode. In the manual drive mode, the motor switch(es) 110 disable operation of the motor(s) 104. The user causes the robot 102 to move by exerting force (e.g., muscle power) on the body 118 and/or on the handle(s) 126 to push or pull the robot 102, thereby causing the robot 102 to move. For instance, in the manual drive mode, the wheel(s) 106 rotate about their respective axes to enable the user to move (e.g., push) the robot 102.

The example robot 102 can operate in a third drive mode, or an assisted drive mode. In the assisted drive mode, the motor control circuitry 108 causes the motor(s) 104 to generate power in response to detection of force applied by the user at the robot 102 to assist the user in moving (e.g., pushing) the robot 102. In particular, in the example of FIG. 1, the motor control circuitry 108 causes the motor(s) 104 to generate power in response to detection of force applied by the user on the handle(s) 126 of the robot 102. The example robot 102 includes assisted drive mode control circuitry 138 to cause the motor(s) 104 of the robot 102 to move the robot 102 while force applied by the user at the handle(s) 126.

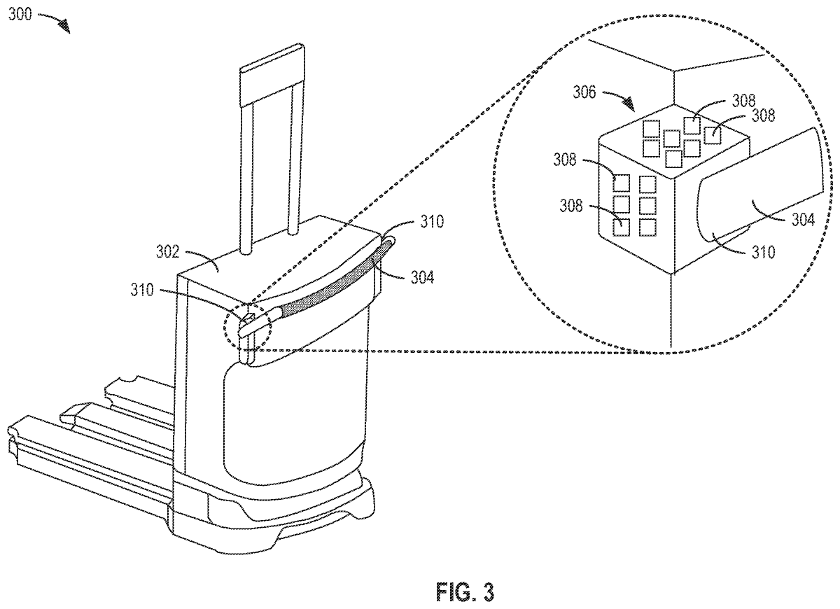

The example handle(s) 126 of FIG. 1 include a malleable material such as an elastomer, a soft metal, etc. The handle(s) 126 include means for registering force applied at the handle. For example, the handle(s) 126 include strain sensors 140 that detect tension or compression at the malleable portion(s) of the handle(s) 126 in response to engagement of the user's hands with the handle(s) 126. The strain sensor(s) 140 can include, for example, strain gauges, fiber optic strain sensor(s), and/or other types of sensors that measure strain mechanically, electrically, or optically. As disclosed herein (FIG. 3), the strain sensor(s) 140 can define sensor arrays of the handle(s) 126. In some examples, the sensor(s) 140 are disposed along at least a portion of a handle 126 (e.g., along a portion of a length of the handle 126). Additionally or alternatively, the sensor arrays defined by the sensor(s) 140 can be located at, for instance, opposing ends of the handle 126. Although examples disclosed herein are discussed in connection with strain sensors, other types of sensors for measuring force could additionally or alternatively be used.

The example assisted drive mode control circuitry 138 analyzes the outputs of the strain sensor(s) 140 to detect force applied at the handle(s) 126 and to facilitate movement (e.g., acceleration, turning) of the robot 102 in response to the applied force. In some examples, the assisted drive mode control circuitry 138 performs a comparative analysis of outputs of sensors located at, for example, opposing ends of the handle 126 to detect differences in force applied at different portions of the handle (e.g., which can indicate that the user wishes to turn the robot 102 in a particular direction), to detect that force is applied on one region of the handle 126 but not elsewhere relative to the handle 126 (e.g., which can indicated that the user is applying one hand to the handle 126), etc. Based on the detected properties of the force applied at the handle(s) 126, the assisted drive mode control circuitry 138 generates instructions to cause the motor(s) 104 to facilitate movement of the robot 102 during the application of user force.

For example, the assisted drive mode control circuitry 138 determines an acceleration of the robot 102 based on the force applied at the handle(s) and a mass of the robot (or a mass of the robot and a load carried by the robot 102 as determined based on outputs of the weight sensor(s) 135). In some examples, the assisted drive mode control circuitry 138 implements rule(s) that indicate that the robot 102 should travel with constant acceleration. In some examples, the rule(s) define, for example, acceleration limits, velocity thresholds, etc. The assisted drive mode control circuitry 138 generates instructions that are transmitted to the motor control circuitry 108 to cause the motor(s) 104 to rotate the wheel(s) 106 of the robot 102.

The assisted drive mode control circuitry 138 can determine (e.g., predict, infer) an intent of the user with respect to turning the robot 102 based on differential measurements output by the sensor(s) 140 at different locations relative to the handle 126. For example, if the assisted drive mode control circuitry 138 determines that an amplitude of force applied at a right side of the handle 126 is greater than the force applied at a left side of the handle 126, the assisted drive mode control circuitry 138 can determine that the user wishes to turn the robot 102 to the right. The assisted drive mode control circuitry 138 generates instructions to cause, for instance, the motor(s) 104 to generate torque to assist with causing the wheel(s) 106 to turn right or left.

In some examples, the assisted drive mode control circuitry 138 accesses a driver profile associated with a user or operator of the robot 102. The driver profile can define user preferences such as a sensitivity of the strain sensor(s) in detecting user input(s) at the handle(s) 126, minimum force detected for causing the robot 102 to move, maximum speeds or acceleration of the robot 102, etc. The driver profile information can be entered via, for instance, a user application executed by the user device 144 and accessed via a display screen of the user device 144 and/or a user application executed by the robot 102 and accessed via the display screen 120 of the robot. In some examples, the driver profile for a user may be provided by the task orchestrator system 137 when a user is assigned to the robot 102. The user can make changes to the driver profile (e.g., adjust sensitivity of the sensors) over time.

As a result of the operation of the motor(s) 104 in connection with manipulation (e.g., pushing, turning) of the robot 102 by the user via the handle(s) 126, an exertion level by the user to move the robot 102 can be reduced. In some examples, the assisted drive mode control circuitry 138 causes the robot 102 to switch from operating in the autonomous drive mode to the assisted drive mode in response to, for instance, outputs of the handle position sensor(s) 130 indicating that the handle(s) 126 have moved from the stowed position to the deployed position. In some examples, the assisted drive mode control circuitry 138 causes the robot to switch from operating in the assisted drive mode to the autonomous in response to, for instance, outputs of the handle position sensor(s) 130 indicating that the handle(s) 126 have moved from the deployed position to the stowed position. In some examples, the user can additionally or alternatively provide inputs via, for instance, the display screen 120 to cause the robot 102 to switch between the autonomous drive mode, the assisted drive mode, and/or the manual drive mode.

In the example of FIG. 1, the assisted drive mode control circuitry 138 is implemented by instructions executed on the programmable circuitry 134 of the robot 102. However, in other examples, the assisted drive mode control circuitry 138 is implemented by instructions on programmable circuitry 142 of a user device 144 and/or on the cloud-based device(s) 146. In other examples, the assisted drive mode control circuitry 138 is implemented by dedicated circuitry located on one or more of the robot 102 and/or the user device 144. In some examples, one or more components of the example assisted drive mode control circuitry 138 are implemented by the on-board programmable circuitry 134 of the robot 102 and one or more other components are implemented by the programmable circuitry 142 of the user device 144 and/or the cloud-based device(s) 146. These components may be implemented in software, firmware, hardware, or in combination of two or more of software, firmware, and hardware.

Although in examples disclosed herein the assisted drive mode control circuitry 138 is discussed as implemented by programmable circuitry (e.g., machine-readable instructions executed by the programmable circuitry 134), the assisted drive mode circuitry 138 can additionally or alternatively be implemented as hardware for detecting force at the handle(s) 126 and cause the motor(s) 104 to provide outputs. Thus, examples disclosed herein may be implemented in hardware, software, or combinations thereof.

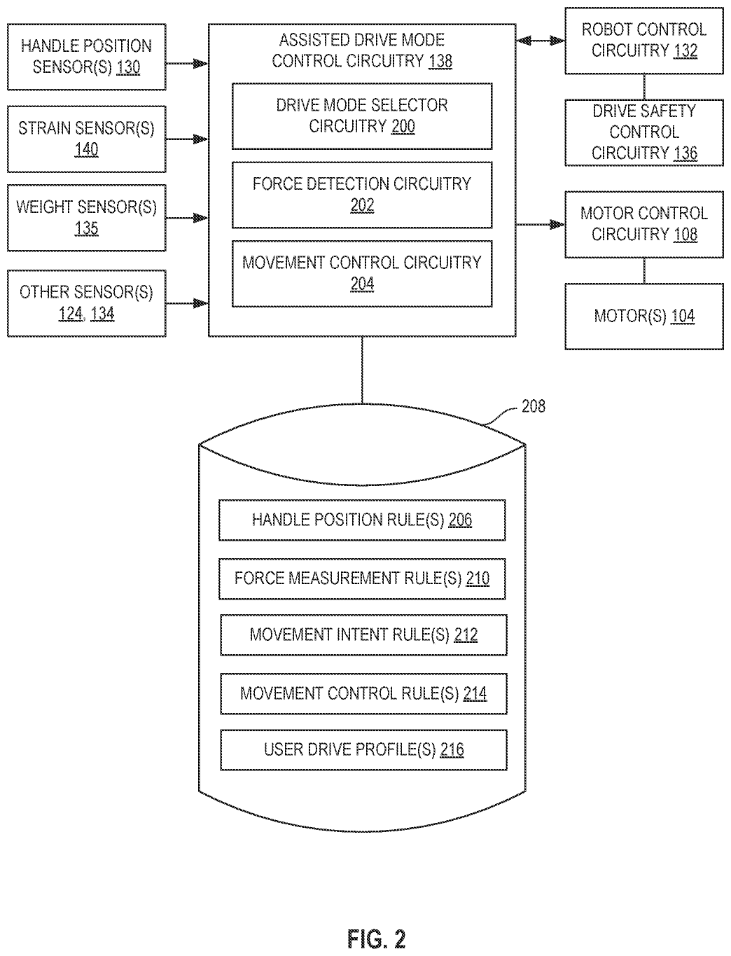

FIG. 2 is a block diagram of an example implementation of the assisted drive mode control circuitry 138 of FIG. 1 to facilitate movement of the example robot 102 of FIG. 1 responsive to force applied by a user at the handle(s) 126 of the robot 102. The assisted drive mode control circuitry 138 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the assisted drive mode control circuitry 138 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

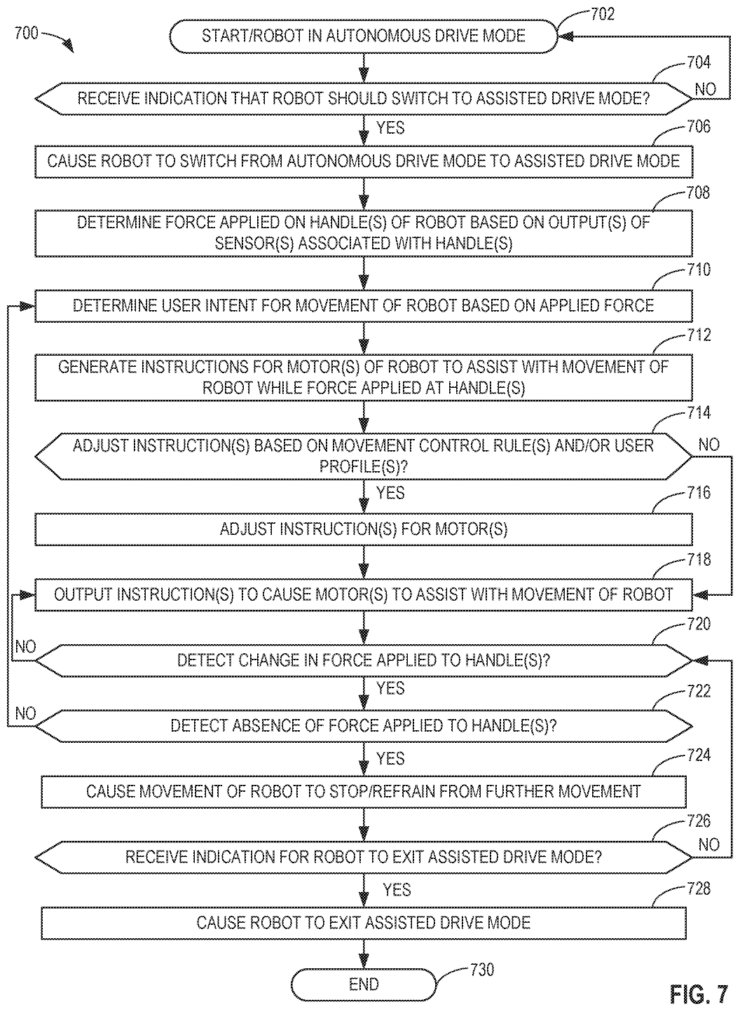

The example assisted drive mode control circuitry 138 of FIG. 2 includes drive mode selector circuitry 200, force detection circuitry 202, and movement control circuitry 204. In some examples, the drive mode selector circuitry 200 is instantiated by programmable circuitry executing drive mode control instructions and/or configured to perform operations such as those represented by the flowchart of FIG. 7. In some examples, the force detection circuitry 202 is instantiated by programmable circuitry executing drive mode control instructions and/or configured to perform operations such as those represented by the flowchart of FIG. 7. In some examples, the movement control circuitry 204 is instantiated by programmable circuitry executing drive mode control instructions and/or configured to perform operations such as those represented by the flowchart of FIG. 7.

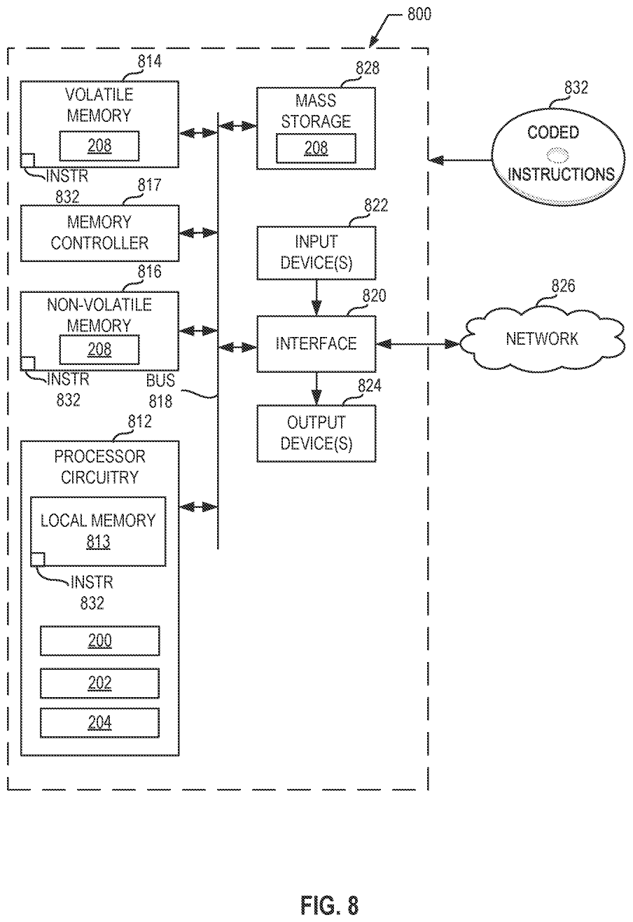

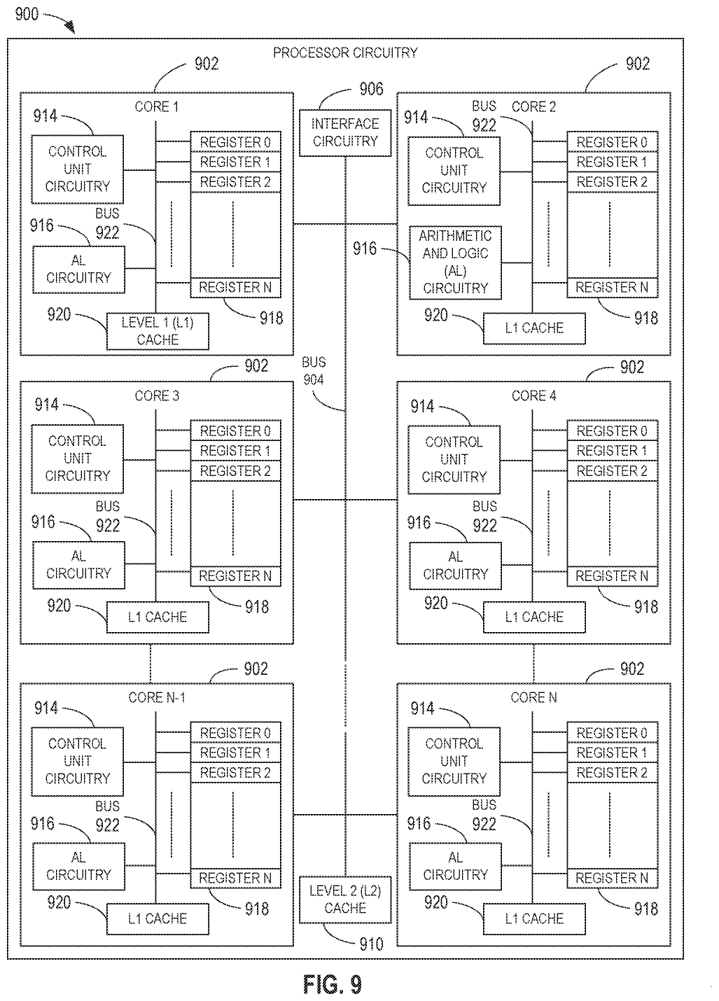

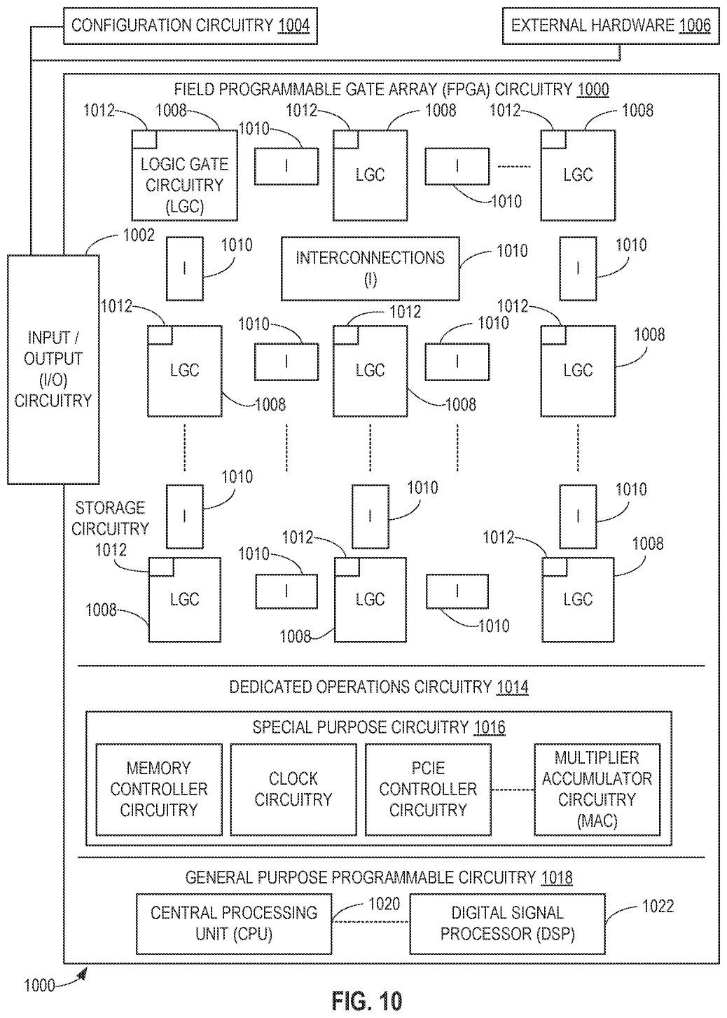

In some examples, the apparatus includes means for controlling a drive mode of a robot. For example, the means for determining may be implemented by the drive mode selector circuitry 200. In some examples, the drive mode selector circuitry 200 may be instantiated by programmable circuitry such as the example programmable circuitry 812 of FIG. 8. For instance, the drive mode selector circuitry 200 may be instantiated by the example microprocessor 900 of FIG. 9 executing machine executable instructions such as those implemented by at least blocks 704, 706, 726, 728 of FIG. 7. In some examples, the drive mode selector circuitry 200 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the drive mode selector circuitry 200 may be instantiated by any other combination of hardware, software, and/or firmware. For example, the drive mode selector circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the apparatus includes means for detecting force. For example, the means for detecting may be implemented by the force detection circuitry 202. In some examples, the force detection circuitry 202 may be instantiated by programmable circuitry such as the example programmable circuitry 812 of FIG. 8. For instance, the force detection circuitry 202 may be instantiated by the example microprocessor 900 of FIG. 9 executing machine executable instructions such as those implemented by at least blocks 708, 720, 722 of FIG. 7. In some examples, the force detection circuitry 202 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the force detection circuitry 202 may be instantiated by any other combination of hardware, software, and/or firmware. For example, the force detection circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the apparatus includes means for controlling movement of a robot. For example, the means for controlling may be implemented by the movement control circuitry 204. In some examples, the movement control circuitry 204 may be instantiated by programmable circuitry such as the example programmable circuitry 812 of FIG. 8. For instance, the movement control circuitry 204 may be instantiated by the example microprocessor 900 of FIG. 9 executing machine executable instructions such as those implemented by at least blocks 710, 712, 714, 716, 718, 724 of FIG. 7. In some examples, the movement control circuitry 204 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the movement control circuitry 204 may be instantiated by any other combination of hardware, software, and/or firmware. For example, the movement control circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The drive mode selector circuitry 200 of FIG. 2 detects when the handle(s) 126 have moved from the stowed position to the deployed position based on, for instance, outputs of the handle position sensor(s) 130 associated with the handle(s) 126 (e.g., indicating that the lock(s), latch(es), switch(es) 128 for the handle(s) 126 have been released). In some examples, the drive mode selector circuitry 200 detects that user input(s) have been received at the robot 102 instructing the robot 102 to switch to the assisted drive mode (selection of a button, an input provided via the display screen 120). In some examples, the drive mode selector circuitry 200 responds to a user-activated switch that is separate from the handle(s) 126, wherein the state of the switch informs the drive mode selector circuitry 200 that the user wishes to operate the robot 102 in the assisted drive mode. In response to determining that the handle(s) 126 are in the deployed position, the drive mode selector circuitry 200 communicates with the robot control circuitry 132 and/or the motor control circuitry 108 to cause the robot 102 to switch from the autonomous drive mode to the assistive drive mode. In some examples, the drive mode selector circuitry 200 determines that the robot 102 should operate in the assisted drive mode based on handle position rule(s) 206. For example, the handle position rule(s) 206 can set forth that if output(s) of the handle position sensor(s) 130 indicate that the handle(s) 126 have been in the deployed position for a threshold period of time, the drive mode selector circuitry 200 should cause the robot 102 to operate in the assisted drive mode.

The handle position rule(s) 206 can be defined by user input(s) and stored in a database 208. In some examples, the assisted drive mode control circuitry 138 includes the database 208. In some examples, the database 208 is located external to the assisted drive mode control circuitry 138 in a location accessible to the assisted drive mode control circuitry 138 as shown in FIG. 2.

The force detection circuitry 202 of FIG. 2 analyzes the outputs of the strain sensor(s) 140 to detect force applied by the user on the handle(s) 126. In some examples, the force detection circuitry 202 compares the outputs of the sensor(s) 140 to a minimum threshold force for causing the robot 102 to move in response to force applied at the handle(s). The minimum threshold force can be defined by force measurement rule(s) 210 stored in the database 208. The minimum threshold force can be defined to avoid unintentional touches on the handle(s) 126 (e.g., light touches, brushes of the user against the handle(s) 126) from causing movement of the robot 102.

Based on the analysis of the strain sensor output(s), the force detection circuitry 202 detects whether the user is using one hand or two hands to apply force to the handle(s) 126. For example, the force detection circuitry 202 can analyze differential measurements from the sensor(s) 140 at the respective ends of the handle 126 to detect whether one hand or two hands are on the handle 126 at a given time. For example, the force detection circuitry 202 can detect that (a) force applied to the handle 126 has been measured by a first sensor 140 and a second sensor 140, where the first and second sensors 140 are located within a threshold distance of each other and (b) no other sensor(s) 140 associated with the handle 126 are registering force. Based on this analysis and the force measurement rule(s) 210, the force detection circuitry 202 determines that the user intends to move (e.g., push) the robot 102 using one hand (e.g., a one-handed drive mode).

When the force detection circuitry 202 determines that the user is moving the robot 102 with one hand on the handle 126, the force detection circuitry 202 may analyze differences in outputs of the strain sensors 140 spaced closer together relative to the handle 126 to detect the torque produced at different portions (e.g., opposing edges) of the user's hand that is engaged with the handle. As disclosed herein, the movement control circuitry 204 can determine (e.g., predict) the user's intent to turn the robot 102 based on the differences in torque applied using different portions of the user's hand (e.g., pressing a side of the user's hand against the handle with greater force than an opposing side of the hand). As also disclosed herein, in response to the detection of the one-handed operation of the robot 102, the movement control circuitry 204 can adjust the output(s) of the motor(s) 104 to reduce the amount of force required by the user to move the robot 102.

In other examples, the force detection circuitry 202 determines that the user has both hands on the handle(s) 126 based on the outputs of the strain sensors 140 and the force measurement rule(s) 210. For example, the force detection circuitry 202 can determine that the user has both hands on the handle(s) 126 based on outputs of sensor arrays at opposing ends of the handle each detecting tension or compression of the handle 126 within a threshold range. When the force detection circuitry 202 determines that both hands are on the handle 126, the force detection circuitry 202 analyzes differential measurements between the strain sensors 140 at, for instance, the respective ends of the handle 126. The force detection circuitry 202 can use the differential measurements from sensors at, for instance, opposing ends of the handle 126 to detect whether the user is exerting more force using one of his or her hands on the handle 126 rather than the other (e.g., changes in torque applied by the user at the handle 126, which could indicate that the robot 102 should turn).

The force detection circuitry 202 can detect changes in the application of force by the user at the handle(s) 126 based on the output(s) of the sensor(s) 140 over time. For example, the force detection circuitry 202 can identify when the user has removed a hand from the handle 126 based on the changes in the differential sensor measurements and the force measurement rule(s) 210. The force detection circuitry 202 can detect when the user is no longer engaged with the handle(s) 126 based on changes in the outputs of the sensors 140 indicating that the force applied by the user has fallen below a threshold or that the sensors 140 are not registering applied forces at the handle(s) 126. The force detection circuitry 202 communicates with the movement control circuitry 204 to cause the robot 102 to move in response to the analysis of the outputs of the sensors 140.

The movement control circuitry 204 of FIG. 2 generates instructions to cause the robot 102 to move in response to force applied by the user at the handle(s) 126, registered by the strain sensor(s) 140, and determined by the force detection circuitry 202. For example, the movement control circuitry 204 determines acceleration of the robot 102 based on the force applied at the handle(s) 126 and a mass of robot 102 (or a mass of the robot 102 including a load carried by the robot 102, where the mass can be determined based on outputs of the weight sensor(s) 135). The movement control circuitry 204 generates instructions to cause the motor(s) 104 to assist with movement of the robot 102 in response to the force applied. The movement control circuitry 204 transmits the instructions to the motor control circuitry 108, which causes the motor(s) 104 generate outputs to propel the robot 102 while the user is exerting force on the handle(s) 126.

The movement control circuitry 204 analyzes force measurement data generated by the force detection circuitry 202 to determine (e.g., predict) an intent of the user when interacting with the robot 102 via the handle(s) 126. For example, the movement control circuitry 204 may consider a center of mass of the robot 102 to be at the center point of the robot 102. Based on the differential sensor measurements determined by the force detection circuitry 202, the movement control circuitry 204 identifies that the user is exerting more force on the handle 126 using, for instance, his or her right hand. As a result, the movement control circuitry 204 determines that the user wishes to turn the robot 102 to the right. The movement control circuitry 204 generates instructions to facilitate turning of the robot 102 to the right. For instance, the movement control circuitry 204 instructs the motor(s) 104 to output torque to move a wheel axle of the robot 102 to change the direction of the wheel(s) 106.

The movement control circuitry 204 determines (e.g., predicts) the intent of the user based on movement intent rule(s) 212 stored in the database 208. The movement intent rule(s) 212 can define, for instance, expected movements to be performed by the user with respect to using the handle(s) 126 to move the robot 102 and associated characteristics of applied force. For instance, the movement intent rule(s) 212 can indicate differential force thresholds for determining that a user wishes to turn the robot 102 when two hands are engaged with the handle 126. The movement intent rule(s) 212 can indicate differential force thresholds for determining that a user wishes to turn the robot 102 when one hand is engaged with the handle 126. The movement intent rule(s) can indicate force thresholds for determining that the user wishes to reduce a speed of or stop movement the robot 102 (e.g., pulling on the handle(s) 126) and/or force thresholds for determining that the user wishes to increase a speed of the robot 102 (e.g., increased pushing on the handle(s) 126). In some examples, the movement control circuitry 204 can be trained using machine learning to determine user intent in moving the robot 102 based on interactions with the handle(s) 126.

The movement control circuitry 204 executes movement control rule(s) 214 to direct movement of the robot 102 based on (e.g., user-defined) thresholds, limits, ranges, etc. For instance, the movement control rule(s) 214 can define maximum acceleration and/or velocity values for the robot 102 (e.g., maximum acceleration regardless of the force input). The movement control rule(s) 214 can indicate that when the force detection circuitry 202 detects, based on the sensor outputs, that neither of the hands of the user are engaged with the handle(s) 126, then the movement control circuitry 204 should generate instructions to cause movement of the robot 102 to stop. For instance, the movement control circuitry 204 can generate instructions to cause the brake(s) 112 (FIG. 1) to activate, the motor(s) 104 to stop generating power outputs, etc. The movement control rule(s) 214 are stored in the database 208.

As another example, if the force detection circuitry 202 determines that only one hand of the user is on the handle 126, the movement control circuitry 204 can determine, based on the movement control rule(s) 214, that the user can pull the robot 102 while the robot 102 is in the assisted drive mode. However, for safety reasons, the movement control rule(s) 214 can indicate that one-handed pushing of the robot 102 is not permitted in the assisted drive mode. In such examples, the movement control circuitry 204 can generate instructions to cause the motor(s) 104 to assist with movement in one direction (i.e., the direction corresponding to pulling the robot 102) but not the other direction (i.e., the direction corresponding to pushing the robot 102). In response to the detection of the one-handed operation of the robot 102, the movement control circuitry 204 can cause the motor(s) 104 to adjust (e.g., increase) the power output(s) to reduce the amount of force required by the user to move the robot 102 in the one-handed mode as compared to when two hands are used to manipulate the robot 102.

In some examples, the movement control circuitry 204 use outputs of other sensors of the robot 102 (e.g., the navigation sensor(s) 124, the image sensor(s) 131) and/or information from the drive safety control circuitry 136 to, for instance, adjust assisted movement of the robot 102 in the environment. For instance, the drive safety control circuitry 136 and/or image data output by the image sensor(s) 131 and analyzed by the movement control circuitry 204 can indicate that there are obstacle(s) in a travel path of the robot 102 while the robot 102 is operating in the assisted drive mode. In response and based on the movement control rule(s) 214, the movement control circuitry 204 can, for instance, instruct the motor(s) 104 and/or the brake(s) 112 to stop movement of the robot 102, cause alert(s) to be output via the display screen 120 and/or the speaker(s) 124, etc.

In some examples, the movement control circuitry 204 adjusts the movement control rule(s) 214 for a particular user based on a user drive profile 216 for the user. The movement control circuitry 204 can access the user drive profile(s) 216 from, for example, the task orchestrator system 137 (FIG. 1) and/or a user application (e.g., a user authentication application). The user drive profile(s) 216 can define user preferences with respect to operation of the robot 102 in the assisted drive mode. For example, the user drive profile(s) 216 can indicate preferred sensitivity level(s) of the strain sensor(s) 140 for detecting intent to move the robot 102, preferred velocity of the robot 102, etc. The movement control circuitry 204 adjusts the instruction(s) provided to the motor control circuitry 108 with respect to assisted movement of the robot 102 to adhere to or effect a driving profile associated with the user operating the robot 102 at a particular time. The user may make changes to the driving profile 216 (e.g., increase/reduce the sensitivity of the strain sensors 140). The user driving profile(s) can be stored in the database 208 (e.g., local storage associated with the robot 102) or stored elsewhere (e.g., on a server and then retrieved responsive to receiving information of the user from the task orchestrator system 137 and/or a user authentication application; at a database associated with the task orchestrator system 137, etc.).

While an example manner of implementing the assisted drive mode control circuitry 138 of FIG. 1 is illustrated in FIG. 2, one or more of the elements, processes, and/or devices illustrated in FIG. 2 may be combined, divided, re-arranged, omitted, eliminated, and/or implemented in any other way. Further, the example drive mode selector circuitry 200, the example force detection circuitry 202, the example movement control circuitry 204, and/or, more generally, the example assisted drive mode control circuitry 138 of FIG. 2, may be implemented by hardware alone or by hardware in combination with software and/or firmware. Thus, for example, any of the example drive mode selector circuitry 200, the example force detection circuitry 202, the example movement control circuitry 204, and/or, more generally, the example assisted drive mode control circuitry 138, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example assisted drive mode control circuitry 138 of FIG. 2 may include one or more elements, processes, and/or devices in addition to, or instead of, those illustrated in FIG. 2, and/or may include more than one of any or all of the illustrated elements, processes and devices.

FIG. 3 illustrates an example robot 300 in accordance with teachings of this disclosure. The example robot 300 of FIG. 3 has a form factor resembling a pallet jack truck. However, the example robot 300 can have other form factors, such as a shopping cart design with one or more storage bins.

The example robot 300 of FIG. 3 includes a body 302 and a handle 304 coupled to the body 302. As shown in FIG. 3, the handle 304 resembles the handle of, for example, a shopping cart, in that the handle 304 has a length extending relative to a width of at least a portion of the body 302. The handle 304 includes a malleable material such as an elastomer, a soft metal, etc. In the example of FIG. 3, the handle 304 is shown in a deployed position. In the deployed position, the handle 304 is extended relative to the body 302 such that a user can grasp the handle 304 (e.g., the user can wrap his or her hand and fingers around the handle 304 to push or pull the robot body 302).

The example handle 304 includes two sensor arrays 306 including strain sensors 308 (e.g., the strain sensors 140 of FIG. 1). In the example of FIG. 3, the sensor arrays 306 are located at opposing ends 310 of the handle. One of the sensor arrays 306 is shown in an expanded view in FIG. 3. As shown in FIG. 3, the sensor array 306 is defined by a plurality of strain sensors 308. The strain sensors 308 can be arranged in a symmetrical pattern, such as rows or a rosette pattern, or in a non-symmetrical pattern (e.g., random placement of the sensors 308). The strain sensors 308 detect tension or compression resulting from force applied by the user on the malleable portion(s) of the handle 304. In some examples, the handle 304 may be rigid, but an interface between the handle 304 and the body 302 of the robot 300 may include a malleable material to accommodate the sensors 308 to detect force on the handle 304.

In the example of FIG. 3, the location of the sensors 308 at the ends of the handle 304 rather than, for instance, along portion(s) of a length of the handle 304 can protect the sensors 308 from damage and facilitate ease of coupling the sensors 308 to, for example, cables or other electronic components within the body 302 of the robot 300. For instance, a portion of the respective ends of the handle 304 may extend into the robot body 302. In some examples, the sensor array(s) 306 are disposed internal to the body 302 of the robot 300 rather than external to the body 302 to further protect the sensors 308. Also, positioning the sensor array(s) 306 at the ends of the handle 304 can facilitate ease of replacement of the material of the handle 304 and/or the handle 304 itself (e.g., as compared to if the sensors 308 were located on the handle 304). However, one or more of the sensors 308 may additionally or alternatively be disposed along the length of the handle 304.

FIG. 4 illustrates the example robot 300 of FIG. 3 with the handle 304 in a stowed position relative to the deployed position shown in FIG. 3. As disclosed herein, in some examples, the handle 304 is moveable relative to the body 302 of the robot 300. In the stowed position of FIG. 4, the handle 304 is retracted relative to the robot body 302 as compared to the deployed position of FIG. 3. For example, in the stowed position, the handle 304 can be proximate to or at least partially resting against the body 302 of the robot 300. In some examples, the handle 304 is maintained in the stowed position via locks or latches (e.g., the lock(s), latch(es) 128 of FIG. 1). To move the handle 304 to the deployed position, the user can release any lock(s) or latch(es) and/or select any buttons or switches and move (e.g., pivot, lift) the handle 304.

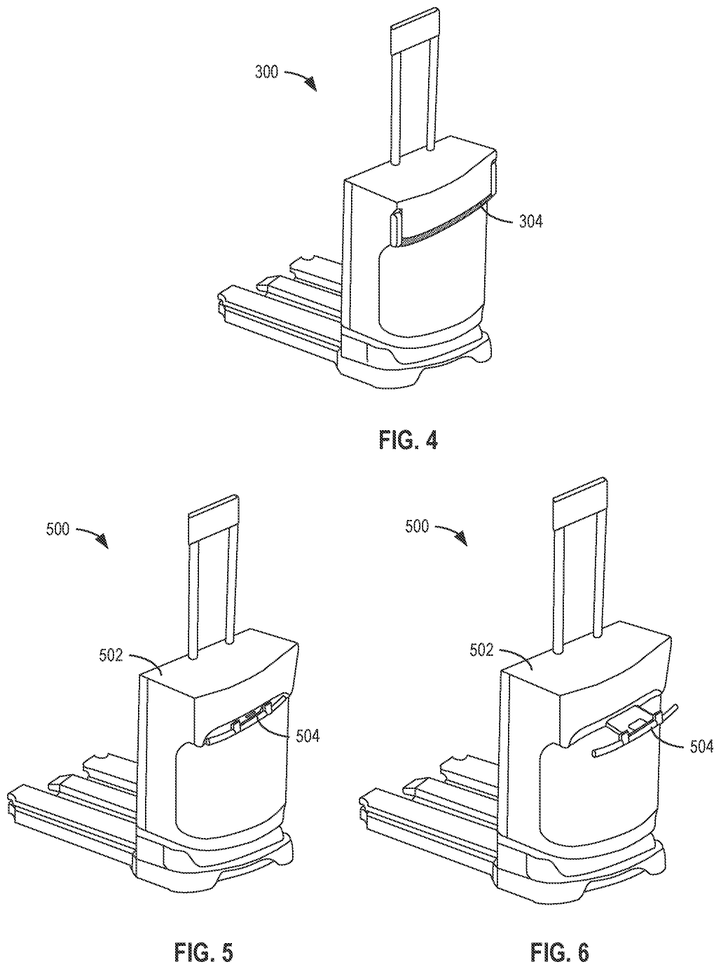

FIG. 5 illustrates another example robot 500 including a body 502 and a handle 504 supported by the body 502. In the example of FIG. 5, the handle 504 is in a stowed position. FIG. 6 illustrates the robot 500 of FIG. 5 with the handle 504 in a deployed position. To move the handle 504 to the deployed position, a user may release any locks, latches, or switches that maintain the handle 504 in the stowed position and pull the handle 504 away from the robot body 502. As disclosed herein, in some examples, the drive mode selector circuitry 200 of the example assisted drive mode control circuitry 138 of FIG. 2 causes the robot 500 to switch from the autonomous drive mode to the assisted drive mode responsive to the handle 504 moving from the stowed position to the deployed position.

At least a portion of the handle 504 of FIGS. 5 and 6 includes a malleable material. The handle 504 includes strain sensors (e.g., the sensors 140, 308) to generate outputs indicative of force applied at the handle 504. The sensors can be disposed along at least a length of the handle, at interface(s) coupling the handle 504 to the robot body 502, or located elsewhere such that the sensors can register forces applied to the handle 504 (e.g., the malleable portion(s) of the handle 504).

A flowchart representative of example machine readable instructions, which may be executed by programmable circuitry to implement and/or instantiate the assisted drive mode control 138 of FIG. 2 and/or representative of example operations which may be performed by programmable circuitry to implement and/or instantiate the assisted drive mode control circuitry 138 of FIG. 2, are shown in FIG. 7. The machine readable instructions may be one or more executable programs or portion(s) of one or more executable programs for execution by programmable circuitry such as the processor circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 7, many other methods of implementing the example assisted drive mode control circuitry 138 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed, instantiated, and/or performed by programmable circuitry to control movement of the example robot 102, 300, 500 of FIGS. 1-6 in response to force applied by a user to the robot 102, 300, 500 (e.g., via the handle(s) 126, 304, 504). The example machine-readable instructions and/or the example operations 700 of FIG. 7 begin at block 702, in which the robot 102, 300, 500 is in an autonomous drive mode.

At block 704, the drive mode selector circuitry 200 of the example assisted drive mode control circuitry 138 of FIG. 2 determines if an indication has been received that the robot 102, 300, 500 should switch from the autonomous drive mode to the assisted drive mode. For example, the drive mode selector circuitry 200 can determine that the robot 102, 300, 500 should switch to the assisted drive mode based on the handle position rule(s) 206 and output(s) of the handle position sensor(s) 130 indicating that the handle(s) 126, 304, 504 have moved from the stowed position to the deployed position and/or based on input(s) received at the robot 102, 300, 500 (e.g., via the display screen 120, via button(s)). At block 706, the drive mode selector circuitry 200 causes the robot 102, 300, 500 to switch from the autonomous drive mode to the assisted drive mode by, for instance, communicating with the robot control circuitry 132 and/or the motor control circuitry 108 of the robot 102, 300, 500.

At block 708, the force detection circuitry 202 of the example assisted drive mode control circuitry 138 of FIG. 2 determines a force applied to the handle(s) 126, 304, 504 by a user based on output(s) of sensor(s) 140, 308 associated with the handle(s) 126, 304, 504. For example, the force detection circuitry 202 correlates output(s) of the strain sensor(s) 140, 308 with force applied at the handle(s) 126, 304, 504. Based on the force measurement rule(s) 210, the force detection circuitry 202 can determine if the force satisfies a minimum force threshold for movement of the robot 102, 300, 500; if the force indicates that the user is applying force with one or both hands at the handle(s) 126, 304, 504; if the user is exerting more force with one hand than the other hand or with one portion of a hand than other portions of the same hand; etc.

At block 710, the movement control circuitry 204 of the example assisted drive mode control circuitry 138 of FIG. 2 analyzes the force detected by the force detection circuitry 202 to determine (e.g., predict) user intent with respect to movement of the robot 102, 300, 500. For example, based on the movement intent rule(s) 212 and differential force measurements with respect to outputs of the sensors 140, 308 analyzed by the force detection circuitry 202, the movement control circuitry 204 can determine that the user intends to turn the robot 102, 300, 500 to the left or to the right. In other examples the movement control circuitry 204 can determine that the user intends for the robot 102, 300, 500 to move in a substantially straight direction based on force data from the force detection circuitry 202. At block 712, the movement control circuitry 204 generates instructions to cause the motor(s) 104 of the robot 102, 300, 500 to assist with movement of the robot 102, 300, 500 while the force is applied at the handle(s) 126, 304, 504. The instructions can define, for instance, acceleration of the robot 102, 300, 500, motor torque outputs, turning direction, etc.

In some examples, at block 714, the movement control circuitry 204 determines that the instructions for directing movement of the robot 102, 300, 500 in the assisted drive mode should be adjusted based on the movement control rule(s) 214 and/or user drive profile(s) 216. For example, the movement control circuitry 204 can determine that the user intends to push the robot 102, 300, 500 with one hand on the handle 126, 304, 504 (as detected based on the sensor outputs). However, the movement control rule(s) 214 can indicate that pushing the robot 102, 300, 500 with one hand is not permitted. In such instances, the movement control circuitry 204 refrains from instructing the motor(s) 104 to generate power outputs to move the robot 102.

In some examples, the user drive profile(s) 216 can define, for instance, preferred speeds, force thresholds, etc. for a user of the robot 102, 300, 500 when the robot 102, 300, 500 is operating in the assisted drive mode. The movement control circuitry 204 can adjust the instruction(s) to the motor(s) 104 based on the user drive profile(s) 216 based on the user preferences.

At block 716, the movement control circuitry 204 adjusts the instruction(s) for the motor(s) 104 based on any movement control rule(s) 214 and/or user drive profile(s) 216. At block 718, the movement control circuitry 204 outputs instruction(s) for the motor(s) 104 to cause the motor(s) 104 to operate to assist with movement of the robot 102, 300, 500. For example, the movement control circuitry 204 transmits the instruction(s) to the motor control circuitry 108.

At block 720, the force detection circuitry 202 determines if any changes in the force applied to the handle(s) 126, 304, 504 has been detected. For example, the force detection circuitry 202 monitors the outputs of the sensors 140, 308 over time to detect changes in force applied to the handle(s) 126, 304, 504, such as changes in force measurements registered at different locations of the handle(s) 126, 304, 504; changes in sensor outputs indicating that the user has removed a hand from the handle 126, 304, 504, etc. If no changes in the user-applied force are detected, then the movement control circuitry 204 continues to output instructions for the motor(s) 104 to assist with movement of the robot 102, 300, 500 (block 718).

In some examples, at block 722, the change detected by the force detection circuitry 202 indicates that no force is being applied to the handle(s) 126, 304, 504 while the robot 102, 300, 500 is in the assisted drive mode (i.e., the user has removed both hands from the handle(s) 126, 304, 504). In such examples, at block 724, the movement control circuitry 204 generates instructions for the motor(s) 104 to stop movement of the robot 102, 300, 500 and/or refrain from generating outputs to cause further movement of the robot 102, 300, 500 until the force detection circuitry 202 determines that a user has again applied force to the handle(s) 126. If the force detection circuitry 202 detects changes in the force applied to the handle(s) 126, 304 other than an absence of applied force, then control returns to block 710, where the movement control circuitry 204 determines the user intent for movement of the robot 102, 300, 500 in view of the detected changes (e.g., changes in force (torque) applied by one hand to indicate that the robot 102, 300, 500 should turn).

At block 726, the drive mode selector circuitry 200 determines if an indication that the robot 102, 300, 500 should exit the assisted drive mode has been received. For example, the drive mode selector circuitry 200 can determine that the handle(s) 126, 304, 504 have been returned to the stowed position and/or a user input has been provided indicating that the robot 102, 300, 500 should exit the assisted drive mode. If an indication that the robot 102, 300, 500 should exit the assisted drive mode has not been received, then control returns to block 720, where the force detection circuitry 202 monitors for changes in force applied to the handle(s) 126, 304, 504 (e.g., to detect re-engagement of the hand(s) of the user with the handle(s) 126, 304, 504).

At block 728, the drive mode selector circuitry 200 communicates with the robot control circuitry 132 and/or the motor control circuitry 108 to cause the robot 102, 300, 500 to exit the assisted drive mode and switch to, for instance, the autonomous drive mode. The instructions 700 end at block 730.

FIG. 8 is a block diagram of an example programmable circuitry platform 800 structured to execute and/or instantiate the example machine-readable instructions and/or the example operations of FIG. 7 to implement the assisted drive mode control circuitry 138 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example drive mode selector circuitry 200, the example force detection circuitry 202, and the example movement control circuitry 204.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIG. 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowchart of FIG. 7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart of FIG. 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart of FIG. 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 7. As such, the FPGA circuitry 1000 may be configured and/or structured to effectively instantiate some or all of the operations/functions corresponding to the machine readable instructions of the flowchart of FIG. 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIG. 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIG. 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart of FIG. 7 to perform first operation(s)/function(s), the FPGA circuitry 1000 of FIG. 10 may be configured and/or structured to perform second operation(s)/function(s) corresponding to a second portion of the machine readable instructions represented by the flowchart of FIG. 7, and/or an ASIC may be configured and/or structured to perform third operation(s)/function(s) corresponding to a third portion of the machine readable instructions represented by the flowchart of FIG. 7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

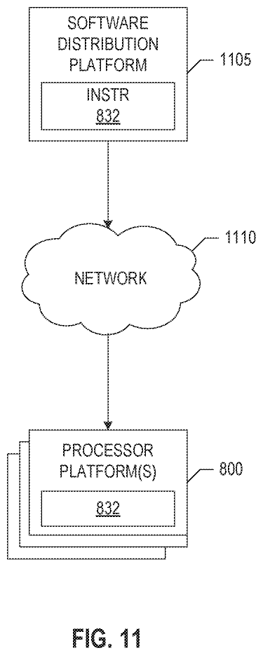

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIG. 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 7, may be downloaded to the example programmable circuitry platform 800, which is to execute the machine readable instructions 832 to implement the assisted drive mode control circuitry 138. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that provide for assisted movement of a robot in response force applied by a user at the robot. Examples robots disclosed herein include handle(s) having strain sensors to outputs indicators of force applied at the handle(s). Based on the detected force, examples disclosed herein instruct motor(s) of the robot to generate output(s) to assist with movement of the robot while the force is applied at the handle. Examples disclosed herein respond to changes in user-applied force to detect, for instance, that the user wishes to turn the robot, and generate corresponding instructions for the motor(s) to assist with the movement. Thus, examples disclosed herein translate force applied at the robot handle to assisted movement of the robot to facilitate ease of operation of the robot while the user is exerting force on the robot.

Example systems, apparatus, and methods to for operating robots in an assisted drive mode are disclosed herein. Further examples and combinations thereof include the following:

Example 1 includes a robot comprising: a body; at least one motor carried by the body; a handle; at least one strain sensor coupled to the handle; and circuitry to determine a measure of force applied to the handle based on one or more outputs of the at least one strain sensor; and cause the at least one motor to generate an output during the application of force to the handle to cause the robot to move responsive to the force applied to the handle based on the measure.

Example 2 includes the robot of example 1, wherein the at least one sensor includes a first strain sensor and a second strain sensor, the first strain sensor coupled to a first end of the handle and the second strain sensor coupled to a second end of the handle, the second end opposite the first end.

Example 3 includes the robot of examples 1 or 2, wherein the first strain sensor is associated with a sensor array including the first strain sensor and a plurality of other strain sensors, the first strain sensor and the plurality of other strain sensors arranged in symmetrical pattern.

Example 4 includes the robot of any of examples 1-3, wherein the first strain sensor and the second strain sensor are disposed in the body.

Example 5 includes the robot of any of examples 1-4, wherein the circuitry is to determine whether the force is applied on the handle by (a) a first hand and a second hand of a user or (b) the first hand and not the second hand; and when the force is applied by the first hand and not the second hand, cause the at least one motor to move the robot in a first direction but not a second direction.

Example 6 includes the robot of example 1, wherein the force is applied on the handle at a first time and the circuitry is to detect a change in the force at a second time relative to a first end of the handle; and generate an instruction to cause the robot to turn based on the detected change in force relative to the first end of the handle.

Example 7 includes the robot of any of examples 1-6, wherein the force is applied on the handle at a first time and the circuitry is to detect an absence of force applied to the handle at a second time; and generate an instruction to cause the at least one motor to refrain from generating the output responsive to the detected absence of force.

Example 8 includes the robot of any of examples 1-7, wherein the handle is moveable between a stowed position and a deployed position relative to the body.

Example 9 includes the robot of any of examples 1-8, wherein the circuitry is to cause the robot to switch from an autonomous drive mode to an assisted drive mode responsive to movement of the handle from the stowed position to the deployed position.

Example 10 includes a robot comprising a body; means for driving movement of the body; a handle coupled to the body and having a length extending relative to a width of at least a portion of the body; means for registering force to generate outputs indicative of force applied to the handle; and means for controlling movement to cause the means for driving to generate an output to cause the robot to move while the means for registering force generates the outputs indicative of the force applied to the handle.

Example 11 includes the robot of example 10, wherein the handle is moveably coupled to the body and further including means for controlling a drive mode of the robot, the means for controlling the drive mode to cause the robot to switch from an autonomous drive mode to an assisted drive mode responsive to movement of the handle.

Example 12 includes the robot of examples 10 or 11, wherein the means for registering force is disposed at an end of the handle.

Example 13 includes the robot of any of examples 10-12, wherein the means for controlling movement is to adjust the output of the means for driving based on a user drive profile.

Example 14 includes the robot of any of examples 10-13, wherein the means for controlling is to cause the means for driving to refrain from generating the output responsive to an indication of an absence of force detected by the means for registering force.

Example 15 includes the robot of any of examples 10-14, wherein the means for controlling is to instruct the means for driving to cause the robot to turn in a first direction based on a differential force measurement, the differential force measurement based on the outputs of the means for registering force.

Example 16 includes a method comprising determining a measure of force applied to a handle of a robot based on one or more outputs of at least one strain sensor associated with the handle; and causing a motor of the robot to generate an output during the application of force to the handle to cause the robot to move responsive to the force applied to the handle based on the measure.

Example 17 includes the method of example 16, further including causing the robot to switch from an autonomous drive mode to an assisted drive mode responsive to movement of the handle from a first position to a second position.

Example 18 includes the method of examples 16 or 17, further including determining the output of the motor based on a user drive profile associated with a user applying the force to the handle.

Example 19 includes the method of any of examples 16-18, wherein the force is applied on the handle at a first time and further including detecting a change in the force at a second time relative to a first end of the handle; and causing the robot to turn based on the detected change in force relative to the first end of the handle.

Example 20 includes the method of any of examples 16-19, wherein the force is applied on the handle at a first time and further including detecting an absence of force applied to the handle at a second time; and generating an instruction to cause the motor to refrain from generating the output responsive to the detected absence of force

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A robot comprising:
a body;
at least one motor carried by the body;
a handle;
at least one strain sensor coupled to the handle; and
circuitry to:
determine a measure of force applied to the handle based on one or more outputs of the at least one strain sensor; and
cause the at least one motor to generate an output during the application of force to the handle to cause the robot to move responsive to the force applied to the handle based on the measure.

2. The robot of claim 1, wherein the at least one sensor includes a first strain sensor and a second strain sensor, the first strain sensor coupled to a first end of the handle and the second strain sensor coupled to a second end of the handle, the second end opposite the first end.

3. The robot of claim 2, wherein the first strain sensor is associated with a sensor array including the first strain sensor and a plurality of other strain sensors, the first strain sensor and the plurality of other strain sensors arranged in symmetrical pattern.

4. The robot of claim 2, wherein the first strain sensor and the second strain sensor are disposed in the body.

5. The robot of claim 1, wherein the circuitry is to:
determine whether the force is applied on the handle by (a) a first hand and a second hand of a user or (b) the first hand and not the second hand; and
when the force is applied by the first hand and not the second hand, cause the at least one motor to move the robot in a first direction but not a second direction.

6. The robot of claim 1, wherein the force is applied on the handle at a first time and the circuitry is to:
detect a change in the force at a second time relative to a first end of the handle; and
generate an instruction to cause the robot to turn based on the detected change in force relative to the first end of the handle.

7. The robot of claim 1, wherein the force is applied on the handle at a first time and the circuitry is to:
detect an absence of force applied to the handle at a second time; and
generate an instruction to cause the at least one motor to refrain from generating the output responsive to the detected absence of force.

8. The robot of claim 1, wherein the handle is moveable between a stowed position and a deployed position relative to the body.

9. The robot of claim 8, wherein the circuitry is to cause the robot to switch from an autonomous drive mode to an assisted drive mode responsive to movement of the handle from the stowed position to the deployed position.

10. A robot comprising:
a body;
means for driving movement of the body;
a handle coupled to the body and having a length extending relative to a width of at least a portion of the body;
means for registering force to generate outputs indicative of force applied to the handle; and
means for controlling movement to cause the means for driving to generate an output to cause the robot to move while the means for registering force generates the outputs indicative of the force applied to the handle.

11. The robot of claim 10, wherein the handle is moveably coupled to the body and further including means for controlling a drive mode of the robot, the means for controlling the drive mode to cause the robot to switch from an autonomous drive mode to an assisted drive mode responsive to movement of the handle.

12. The robot of claim 10, wherein the means for registering force is disposed at an end of the handle.

13. The robot of claim 10, wherein the means for controlling movement is to adjust the output of the means for driving based on a user drive profile.

14. The robot of claim 10, wherein the means for controlling is to cause the means for driving to refrain from generating the output responsive to an indication of an absence of force detected by the means for registering force.

15. The robot of claim 10, wherein the means for controlling is to instruct the means for driving to cause the robot to turn in a first direction based on a differential force measurement, the differential force measurement based on the outputs of the means for registering force.

16. A method comprising:
determining a measure of force applied to a handle of a robot based on one or more outputs of at least one strain sensor associated with the handle; and
causing a motor of the robot to generate an output during the application of force to the handle to cause the robot to move responsive to the force applied to the handle based on the measure.

17. The method of claim 16, further including causing the robot to switch from an autonomous drive mode to an assisted drive mode responsive to movement of the handle from a first position to a second position.

18. The method of claim 16, further including determining the output of the motor based on a user drive profile associated with a user applying the force to the handle.

19. The method of claim 16, wherein the force is applied on the handle at a first time and further including:
detecting a change in the force at a second time relative to a first end of the handle; and
causing the robot to turn based on the detected change in force relative to the first end of the handle.

20. The method of claim 16, wherein the force is applied on the handle at a first time and further including:
detecting an absence of force applied to the handle at a second time; and
generating an instruction to cause the motor to refrain from generating the output responsive to the detected absence of force.
